(19) United States
(12) Patent Application Publication
(10) Pub. No.: US 2026/0293843 A1
(43) Pub. Date: Oct. 1, 2026

(54) PORTABLE CORRAL SYSTEM AND METHODS

(71) Applicant: LINN POST & PIPE, INC., Linn, KS (US)

(72) Inventor: Kyle Peters, Linn, KS (US)

(21) Appl. No.: 19/568,109

(22) Filed: Mar. 16, 2026

Related U.S. Application Data
(60) Provisional application No. 63/771,788, filed on Mar. 14, 2025.

(51) Int. Cl. A01K 3/00

(52) U.S. Cl. CPC A01K 3/001

(57) ABSTRACT

A portable corral system for deploying a corral is provided. Embodiments of the portable corral system of the present invention comprise a pivot axle assembly configured to rotate the wheels in and out of position depending on whether the portable corral system is in transport or getting ready to be deployed. Embodiments of the portable corral system of the present invention comprise a panel lifting system configured to raise the foldable panels of the portable corral above the frame structure to easily ensure that the panels are not damaged in transport. Embodiments of the portable corral system of the present invention further comprise a collapsible alleyway system configured to deploy an alleyway for working cattle or other livestock and then be stowed at the center of the corral to allow more space for stowing foldable panels.

### CROSS-REFERENCE TO RELATED APPLICATIONS

This application claims priority pursuant to 35 U.S.C. 119(e) to U.S. Provisional Patent Application Ser. No. 63/771,788, filed Mar. 14, 2025, the entire disclosure of which is incorporated herein by reference.

### FIELD OF THE INVENTION

The present invention relates generally to livestock management systems. More specifically, the present invention is concerned with portable corral systems and methods.

### BACKGROUND

Ranchers use corrals, also known as enclosures or pens, to gather and keep livestock, such as cattle, in a fixed location to count, sort, brand, load, vaccinate, or otherwise process in some way. Historically, cattle corrals would often be built in remote parts of a cattle ranch so that they could be used to process cattle without the need to bring the cattle a long distance back to the ranch headquarters. However, especially for large ranches, the cost and resources needed to build sufficient corrals throughout the extent of the pastures has the potential to become extremely expensive. Moreover, even with numerous fixed corrals, ranchers may still need to herd the cattle a significant distance to the nearest corral.

More recently, portable corrals have gained in popularity, allowing the corral to be brought to the herd. Unfortunately, the set-up and breakdown of portable corrals can be time consuming, strenuous, and dangerous. Accordingly, it would be beneficial to have a portable corral system that facilitates quick, easy, and safe set-up and breakdown.

During transportation, each panel of the corral is held above the ground, thereby facilitating transportation over the rough and irregular terrain of most pastures. To facilitate transportation, most portable corrals utilize a hitch and wheels. Upon reaching a corral site, the panels are lowered to the ground and spread out to create a desired pen configuration. In this way, the corral system is moved from a transport configuration to a lowered configuration. Unfortunately, when lowering the panels, it can be difficult to prevent the panels from dropping down too quickly, which can damage the panels or injure workers. Accordingly, it would be beneficial to have a system for and method of lowering the panels in a steady and safe fashion.

Transportation wheels can complicate the process of raising and lowering panels. Most corrals have either a wheel that stays on all the time and cannot be move at all, a wheel that can be slid out of a tube to be manually removed, or a wheel that is built into the corral framework that remains attached to the corral at all times during transport and when in use but is lifted up and down with a hydraulic cylinder or by other means.

Those corrals that have permanently attached wheels are designed such that panels fold around the outside of the wheels thereby limiting the quantity of panels they can transport with the corral. This is because the wheels prevent folding of the panels tightly against each other. Other models remove the wheel completely by allowing them to be unpinned and rolled/transported separately to the location. However, this requires additional time and effort to not only attach and reattach the wheels, but also requires additional capacity to transport sets of wheels. These solutions require the wheels be removed for transport to avoid the problem of having them in the way to limit tighter folding.

A third solution is to build the wheels into the corral framework and use a hydraulic cylinder attached to each of the wheel mount systems, so the wheel and arm assembly are lifted into the air allowing the frame of the corral to come into contact with the ground. While this solution requires less effort on the part of the operator, it creates a barrier that includes cylinders, hoses and framework between the operator and the chute side limiting the ability to access the animal. One alternative method used by portable corral manufacturers is a cable and winch system attached from the central frame of the portable corral to the outside of the folding panels. The cable and winch system allows the operators to winch the panels off the ground to reduce the weight being pushed or pulled by the operator during the unfolding process. However, the cable and winch system adds the risk of cable failure, which has the potential to injure the operator. Additionally, the system is limited by the range of the cable. So, these existing “wheel on” systems often provide more drawbacks than solutions.

Furthermore, each of the above systems have little to no ability to adjust the wheel camber according to different weights of the corral for proper wearing of the wheel tread. Permanently mounted and slide in wheel systems also do not give the corral designers the option to make the corral wheel extend under the corral further to allow for a higher frame to ground spacing that is important in rough terrain areas like pastures that corrals are commonly used in. Furthermore, none of the above systems provide for the ability to leave the wheel on and easily remove the wheel if needed. In all existing systems, wheels are either permanently attached (at least for purposes of normal operation) or must be removed for transport. Accordingly, it would be beneficial if there was a wheel system for use with a portable corral that facilitates camber adjustment. It would be further beneficial if such a wheel system allowed for the wheel to stay on when the portable corral is in use without reducing the quantity of panels that can be stowed with and deployed from the portable corral, or be removed by the operator if desired.

Most corrals currently being produced have a double center frame to create an adjustable alleyway in the portable corrals. Those that are using single frame can have an adjustable alleyway but have limitations when doing so. There are problems with each solution.

Double framed portable corrals have an increased cost and weight, sometimes preventing the corrals from being towable by common ranch vehicles, such as ½ or even ¾ ton trucks, and/or requiring dual wheels to support the weight of the system. Accordingly, it would be beneficial to have a lightweight corral system that includes a robust adjustable alley.

Double frames also limit the number of panels that can be included with a portable corral while staying within the legal 102″ trailer width, allowing travel on highways without travel time, speed restrictions, or mandatory signage. Accordingly, it would be beneficial to have an adjustable alleyway that is collapsible, thereby maximizing the number of panels that can be used without exceeding the legal trailer width.

Corrals that lack adjustable alleyways cannot be used for working cattle, but instead are usable solely for gathering them to transport. Existing systems that use a single frame instead of a double frame create the alleyway by folding panels from one of the four frame corners, which reduces the number of frame corners available for hanging panels from, thereby limiting such portable corrals to varieties and pen sizes that can be accomplished with only 3 sets of panels, making such systems less versatile and less desirable. Accordingly, it would be beneficial to have a single frame portable corral system with an adjustable alleyway that does not reduce the number of frame corners available for hanging panels from.

One additional issue with transporting, lowering, and folding out portable corrals is the stowage of panels during transport itself. If the transport bar is set low enough that the panels can easily be rolled into position for transport mode, then they will hang below the frame and are susceptible to damage during transport. If the transport bar is set too high, it may be difficult or impossible to engage the panels with the transport bar at least most of these panels are too heavy to be lifted by a person. And, as discussed herein, other options, such as adding hydraulics, create additional drawbacks. Accordingly, it would be beneficial to have a portable corral system that is capable of stowing panels above the frame during transport while facilitating vertical movement of the panels without the need to add additional hydraulics to the system.

Industry reports show that cattle ranchers, on average, are getting older as a result of less new ranchers coming into the field. These issues associated with portable corrals are magnified when applied to these older ranchers who will have even more difficulty and risk unfolding heavy panels. Therefore, it is desirable to provide a system and/or method to assist an operator in setting up, breaking down, and moving portable corrals and similar systems.

### SUMMARY

The present invention comprises a portable corral system that includes a frame structure and a plurality of associated corral panel sets. The frame structure includes a transport frame and front and aft bulkheads positioned near respective front and aft ends of the transport frame. Each corral panel set is rotatably coupled to one of the bulkheads, with each corral panel set attached to the front bulkhead being a front panel set, and each corral panel set attached to the aft bulkhead being an aft panel set. Each corral panel set includes a primary panel rotatably coupled to a respective bulkhead, thereby rotatably coupling the corral panel set to the respective bulkhead.

At least some of the corral panel sets include one or more extension panels, a first extension panel being rotatably coupled to the primary panel and each subsequent extension panel being rotatably coupled to the immediately preceding extension panel, thereby facilitating movement of the corral panel set between stowed and deployed configurations. Each corral panel set is in its stowed configuration when the corral panel system is in a transport configuration, and at least one corral panel set is in its deployed configuration when the corral panel system is in a selected operational configuration.

Various embodiments of the present invention facilitate quick, easy, and safe set-up and breakdown of the portable corral system.

Various embodiments of the present invention facilitate lowering the corral panels in a steady and safe fashion.

Various embodiments of the present invention include left and right pivot axle assemblies that facilitate camber adjustment of transport wheels. Each pivot axle assembly includes a bracket assembly and a pivot arm assembly rotatably coupled thereto. The bracket assembly is secured to the frame structure, and a pivot pin couples the pivot arm assembly to the bracket assembly. In some such embodiments, removal of the pivot pin facilitates removal and replacement of the pivot arm assembly, thereby facilitating the camber adjustment. In some embodiments, the pivot axle assemblies facilitate movement of the corral panel sets between stowed and deployed configurations while the transport wheels remain coupled with the transport frame.

Various embodiments of the present invention include an adjustable alleyway that is collapsible, thereby maximizing the number of panels that can be used without exceeding the legal trailer width. In some embodiments, the portable corral system includes four corral panel sets, one corral panel set being associated with each of the four corners of the frame structure. In some such embodiments, the transport frame is a single frame.

Various embodiments of the present invention include a lifting system that that facilitates vertical movement of the panels without the need to add additional hydraulics to the system.

Various embodiments of the present invention assist operators in setting up, breaking down, and moving portable corrals and similar systems.

The present invention comprises a portable corral system and method of using the same to deploy a corral using a plurality of folding panels. More specifically the systems and methods of the present invention comprise a novel pivot axle assembly, a collapsible alleyway, and a panel lifting system, each of which providing solutions to the problems in existing portable corral systems described above.

Various embodiments of the present invention include opposed left and right pivot axle assemblies for rotatably attaching respective transport wheels to the frame structure. The pivot axle assembly includes a bracket assembly and a pivot arm assembly removably attached thereto. The bracket assembly is affixed to the frame structure, such as by welding or bolting, and the transport wheels are removably attached to the pivot arm assembly. Each pivot axle assembly is movable between a locked configuration to facilitate transportation of the portable corral system, an unlocked configuration to facilitate movement of the portable corral system from the transport configuration to a lowered configuration, and a swung configuration to facilitate movement of aft panel sets between stowed and deployed configurations.

The pivot axle assembly is designed such that operators no longer have to unpin the wheel for removal to deploy the corral panel sets. This allows the wheels to stay attached to the frame and rotated out of the way of the panels, making set up easier and faster. This offers a solution to the above issues by allowing for a “wheel on” system that is still capable of having the panels folded compactly. Additionally, the pivot axle assembly is adapted for placement on various spots of the corral framework because of its easy attachment to a tube. Furthermore, the pivot axle assembly does not require substantial framework to support it, which is an improvement over prior art systems.

This design does not require a lifting mechanism (such as a hydraulic cylinder) to be attached to the wheel bracket in any way. This allows the corral designers the ability to place the lifting and lowering mechanism of a corral to be placed in an optimal location resulting in less cylinders or jacks being used and those being placed in a less obstructive area to the operator. Since the lifting mechanism is not attached to the wheel assembly in any way, the weight of the corral is the actual mechanism rolling the wheels out away from the frame allowing the frame to lower to the ground to be used. And when the corral is raised the weight of the wheels themselves, and the angle of the attached pivot arm rolls the wheel back into the bracket to allow for pinning into proper position for corral transport. This will result in the wheel assembly being less likely to be damaged over time from over or under extending the powered lifting mechanism.

Embodiments of the pivot axle assembly of the present invention are further configured to adjust the camber of the transport wheels of the corral based on the portable corral system's weight without modifying any of the frame structure that the wheel is attached to. Adjustment of the camber of the transport wheels is made simple and easy by way of the pivot axle assembly.

Various embodiments of the present invention comprise a novel collapsible alley system for deploying an alleyway that can be stowed substantially near the center of the portable corral system's frame. The collapsible alley system, thus, allows for all four corners of a single frame portable corral system to be used for stowing foldable panels while maintaining the ability to deploy an alleyway for working cattle or other livestock. This allows an operator to avoid the aforementioned problems of having to utilize a double framed corral without having to sacrifice the quantity of foldable panels that can be stowed on the portable corral system due to the space needed to stow panels for the alleyway.

Embodiments of the collapsible alleyway system of the present invention utilize two panels that are configured to be folded together and stowed substantially near the center of the portable corral system. To deploy the alleyway, the panels are configured to be rolled towards the exterior edge of the frame structure, thus creating an alleyway between the alley panels and the fixed panels at the center of the portable corral. One of the panels is then folded away from the other to be used as a gate for entry into the alleyway.

Various embodiments of the present invention comprise a novel panel lifting mechanism configured to allow an operator to easily lift the foldable panels above the bottom of the frame structure for transport. The panel lifting mechanism of the present invention utilizes a lifting bar and a hydraulic cylinder to lift the panels above the bottom of the frame structure, where one or more pins will hold the panels for transport. The panel lifting mechanism works together to easily lift the entire set of panels of a portable corral into a lifted position for transport to make folding panels into ready position easy and protect the underneath panel wheels from damage in rough terrain from colliding with the ground.

It will be appreciated that the design is not limited to just portable cattle corral pen systems but can be used in almost all portable livestock equipment solutions farmers and ranchers utilize for their operation. Loading chutes, squeeze chutes, portable tub and alleyway combinations could all benefit from these features.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

Embodiments of the present invention are described in detail below with reference to the attached drawing figures, wherein:

FIG. 1 is a right-side elevation view of an embodiment of a portable corral system of the present invention, the portable corral system shown in a transport configuration.

FIG. 2A is a partial rear perspective view of the embodiment of FIG. 1, left and right pivot axle assemblies of the portable corral system shown in respective locked configurations.

FIG. 2B is the partial rear perspective view of FIG. 2A with the pivot axle assemblies shown in respective unlocked configurations, thereby facilitating movement of the portable corral system from the transport configuration to a lowered configuration.

FIG. 2C is the partial rear perspective view of FIG. 2B with the portable corral system shown in the lowered configuration and the pivot axle assemblies shown in respective swung configurations.

FIG. 3A is a perspective view of a bracket assembly of an embodiment of a pivot axle assembly of the present invention.

FIG. 3b is a sectional view of the bracket of FIG. 3A.

FIG. 4 is a perspective view of a pivot arm of an embodiment of a pivot axle assembly of the present invention.

FIG. 5 is a front elevation view of an embodiment of a portable corral system of the present invention.

FIG. 6A is a partial front perspective view of the embodiment of FIG. 1 with a lifting bar extending through a plurality of panels and a sliding system shown in a pinned configuration.

FIG. 6B is the partial front perspective view of FIG. 6A with a front lifting system shown engaged with left and right lifting cleats of the sliding system to facilitate moving the sliding system away from the pinned configuration.

FIG. 6C is the partial front perspective view of FIG. 6B with the sliding system shown in an unpinned configuration, thereby facilitating movement of the portable corral system from the transport configuration to a lowered configuration, stop pins of the sliding system shown in respective stowed positions.

FIG. 6D is the partial front perspective view of FIG. 6C with the portable corral system shown in the lowered configuration.

FIG. 6E is the partial front perspective view of FIG. 6D after the lifting bar has been removed.

FIG. 7 is a front perspective view of an embodiment of a portable corral system in an operational configuration, a collapsible adjustable alleyway system of the present invention shown in a wide configuration and an associated alley gate shown in a secured configuration.

FIG. 8 is a rear perspective view of the portable corral system of FIG. 7, a tub latch shown in an engaged configuration associated with the alley gate's secured configuration.

FIG. 9A is a top view of the portable corral system of FIG. 7 with the alley gate shown in an open configuration.

FIG. 9B is the top view of FIG. 9A with the alley gate shown in a closed configuration and the tub latch shown in a disengaged configuration.

FIG. 9C is an enlarged scale view of the top view of FIG. 9B with the alley gate and tub latch shown in secured and engaged configurations, respectively.

FIG. 10 is a front perspective view of a frame structure of an embodiment of the present invention.

FIG. 11 is a front perspective view of the frame structure of FIG. 10, shown from a different angle and shown with panels of an adjustable alleyway system positioned thereon, the adjustable alleyway system shown in a collapsed configuration.

The drawing figures do not limit the present invention to the specific embodiments disclosed and described herein. The drawings are not necessarily to scale, emphasis instead being placed upon illustrating the principles of the invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

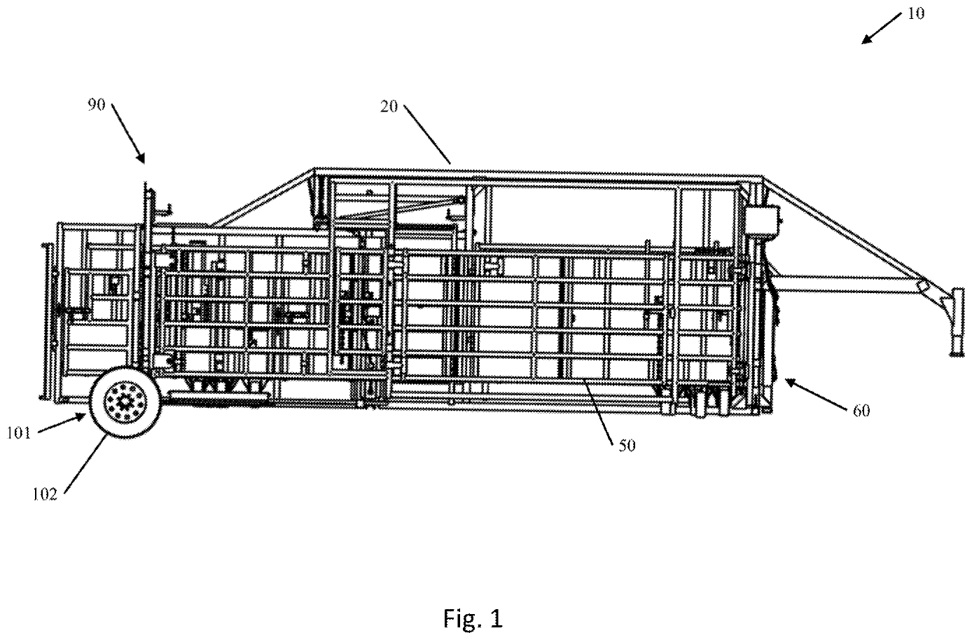

Referring to FIG. 1, the present invention comprises a portable corral system 10 and method of using the same. In various embodiments, the portable corral system 10 is configured to be movable between a variety of configurations including at least a transport configuration, a lowered configuration, and a plurality of operational configurations. The portable corral system 10 comprises a plurality of interconnected panels 50 mounted on a frame structure 20, the panels being configured to selectively form a corral space 902 and/or an adjustable alleyway 901 for livestock when the portable corral system is in a selected operational configuration. In the lowered configuration, the frame structure 20 and the panels 50 are located on or near the ground, with the panels 50 being folded in (stowed) such that they are substantially contained within the frame structure 20. In the transport configuration, the portable corral system is supported by one or more transport wheels 102 located substantially near the back end of the portable corral system 10 such that the portable corral system can be hauled from one location to another without damaging the frame structure 20 or the panels 50. In some embodiments, the corral system includes a panel lifting system 60 to facilitate moving the corral system 10 between its lowered and transport configurations. In some embodiments, the corral system 10 includes a collapsible alleyway system 90 to facilitate moving the corral system 10 between various operational configurations, some utilizing an alleyway and others not. In some such embodiments, the collapsible alleyway system 90 is an adjustable alleyway system, thereby facilitating use of the alleyway with large animals, such as full-size cattle, and smaller animals, such as calves.

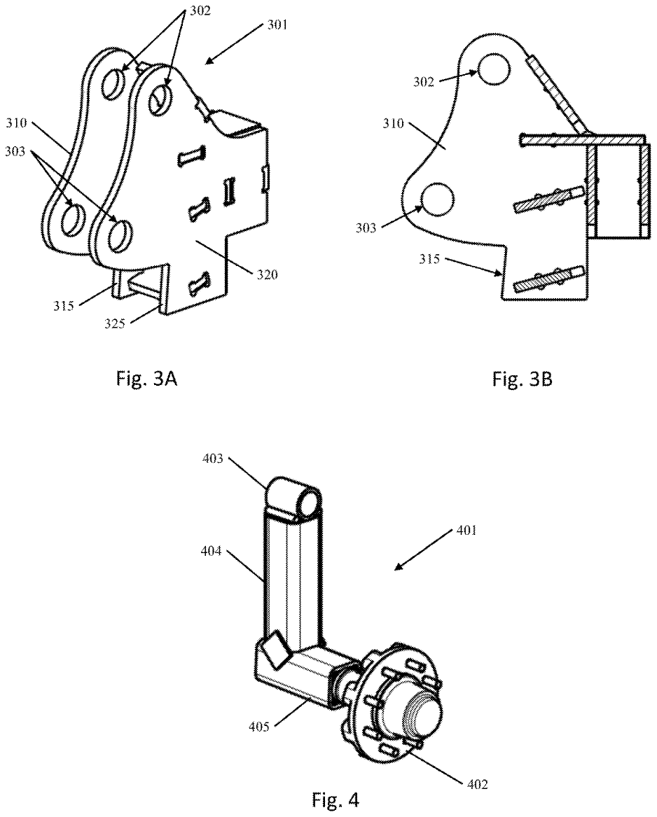

Referring now to FIGS. 1-4, the aft end of an embodiment of the portable corral system of the present invention is shown. In the embodiment shown, the portable corral system includes left and right pivot axle assemblies 101 each connecting a respective transport wheel 102 to the frame structure substantially near the aft end of the frame structure. Each pivot axle assembly 101 includes a bracket assembly 301 and a pivot arm assembly 401 rotatably coupled thereto. Opposing first 310 and second 320 plates of each bracket assembly each define a first aperture 302 and a second aperture 303, each aperture of the first plate 310 being aligned with a respective aperture of the second plate 320 such that the first apertures 302 are configured to receive a pivot pin 104 and the second apertures 303 are configured to receive a retention pin 103. Each pivot arm assembly 401 includes a connection piece 403 configured to receive the pivot pin 104 such that the pivot arm assembly 401 can rotate about the pivot pin 104. The pivot arm 401 is further configured to be substantially held in place between upper portions of the first 310 and second 320 plates of the bracket 301 by the retention pin 103 which restricts the rotation of the pivot arm 401 out of the plates of the bracket.

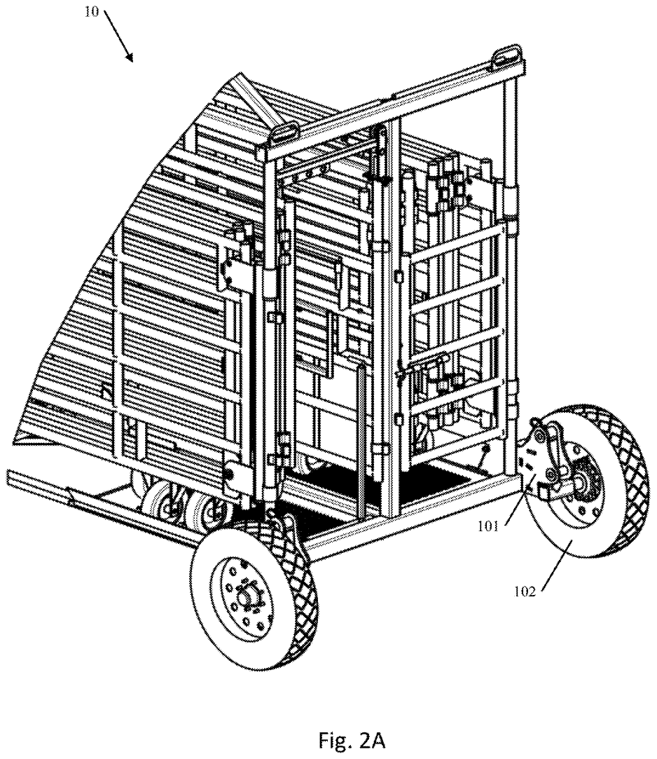

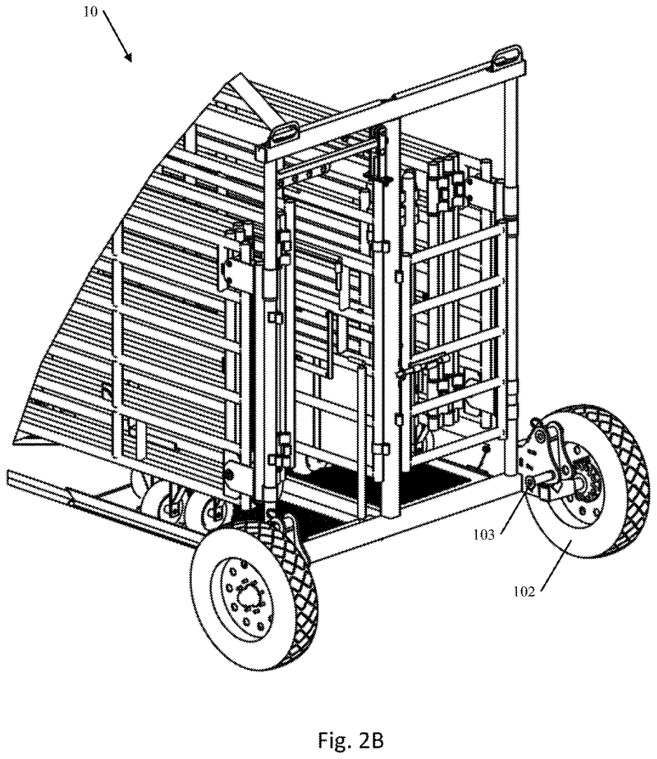

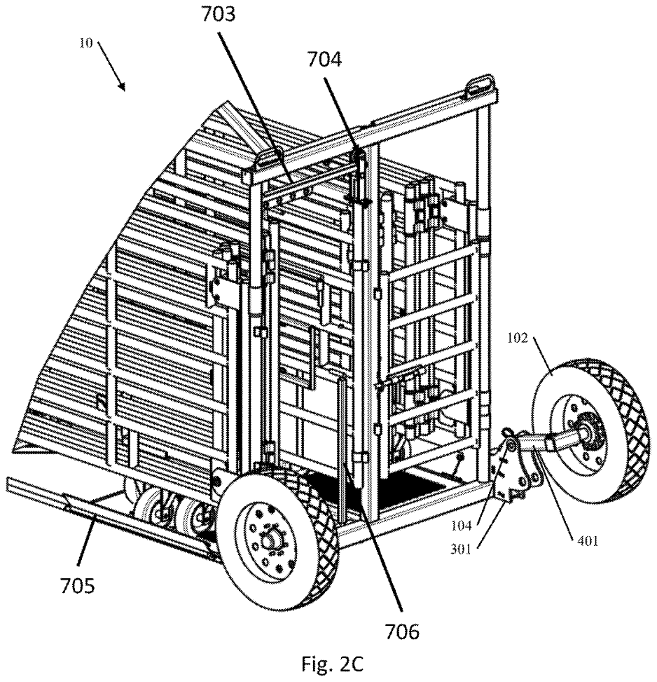

As seen in Fig. la, when the portable corral system of the present invention is in the transport configuration, the pivot axle assemblies 101 are configured to hold each of the respective transport wheels 102 in substantially in place supporting the portable corral system such that the bottom of the portable corral assembly is separated from the ground. The pivot axle assemblies 101 are further configured to allow the wheels to rotate out from beneath the central frame of the portable corral system by removing the retention pin 103, thereby causing the transport wheels 102 to roll out away from the central frame due to the frame's weight, causing the central frame to be lowered to the ground. Thus, the pivot axle assemblies allow the portable corral system to move from the transport configuration to the lowered configuration, as seen in FIGS. 2B and 2C. Additionally, when the lifting mechanism (discussed further below) lifts the portable corral system off of the ground, the weight of the transport wheels 102 and the pivot arm 401 repositions the transport wheels 102 in the transport configuration with the pivot arm 401 rotating back into engagement with the two opposing plates of the bracket 301. In some embodiments, lower portions of the first 310 and second 320 plates define respective first 315 and second 325 front edges defining a maximum angle of rotation for the pivot arm assembly 401. In some such embodiments, the maximum angle of rotation is five degrees less than a vertical position such that the pivot arm assembly 401 is angled slightly aft when rotated against the first 315 and second 325 front edges.

The pivot axle assemblies 101, thus, allow an operator to easily lower the portable corral assembly to the ground for deployment without the use of hydraulics or other form of lifting mechanism attached to the transport wheels 102. The pivot axle assemblies 101 further allow an operator to easily remove each of the respective transport wheels 102 from the portable corral system, if desired, by removing the pivot pin 104 from the pivot axle assembly. As such, the pivot axle assemblies 101 provide significant ease of use for an operator in adjusting the position of the transport wheels 102 relative to the frame, allowing the transport wheels 102 to be left in place while utilizing the portable corral system in the operational configuration, folded up for transport, or removed completely by removing the retention 103 and pivot 104 pins.

Referring to FIG. 4, an embodiment of a pivot arm 401 of the present invention is shown, the pivot arm 401 comprising a first tube 404, a connection piece 403 located on a top end of the first tube 404, a second tube 405 attached to a bottom end of the first tube 404 and extending angularly outward therefrom, and a hub 402 attached to an exterior end of the second tube 405 and configured to be coupled to a transport wheel 102. In various embodiments the angle of attachment between the first tube 404 and the second tube 405 as well as the angle of attachment between the hub 402 and the second tube 405 are configured to ensure that the transport wheels 102 maintain a positive camber when the portable corral system is in the transport configuration. In a preferred embodiment, the angle of attachment between the first tub 404 and the second tube 405 is 92.4 degrees. In some embodiments, the camber of the transport wheels 102 is adjustable to accommodate for differing weights of the portable corral system, such as by modifying or replacing the pivot arm assembly 401. In some such embodiments, the connection between the hub 402 and the second tube 405 is configured to be adjustable such that the angle of connection can be adjusted by an operator to adjust the camber of the transport wheels 102. In some embodiments, side surfaces of the first tube 404 interface with respective inside surfaces of the first 110 and second 120 plates when the first tube 404 of the pivot arm assembly 401 is positioned therebetween.

Various embodiments of the pivot arm 401 comprise a first tubes 404 of various lengths which ensure that the bottom of the portable corral system is separated from the ground by a sufficient distance for safe transport. In some embodiments in which the portable corral system is configured to be transported over rough terrain, the first tube 404 defines a relatively longer length. In some embodiments, a back surface of the second tube 405 interfaces with at least one of the first 315 and second 325 front edges of the bracket assembly when the pivot arm assembly is rotated to a maximum rotation angle. In some embodiments, the second tube 405 extends at least partially past the first tube 404 to facilitate engagement with bot front edges.

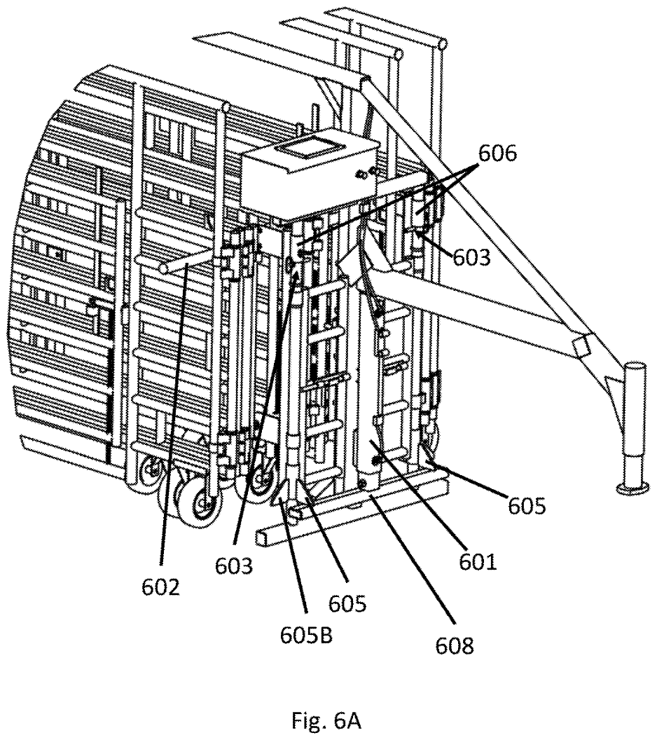

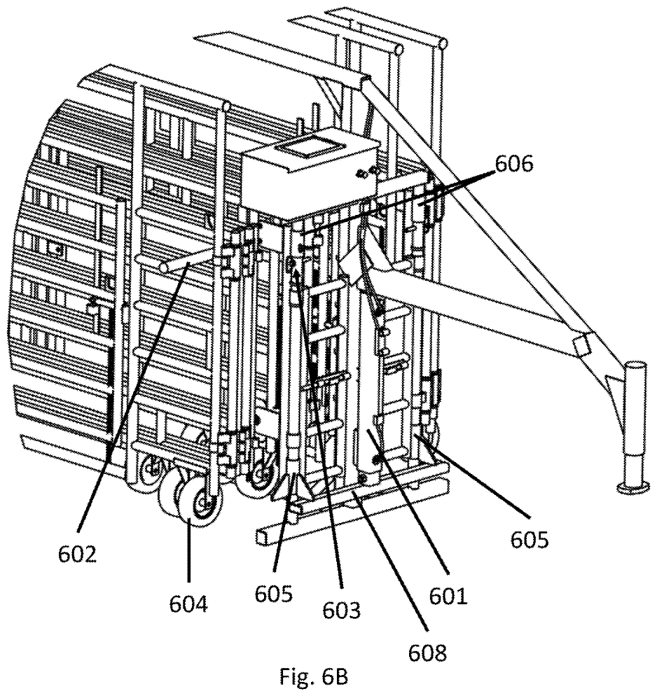

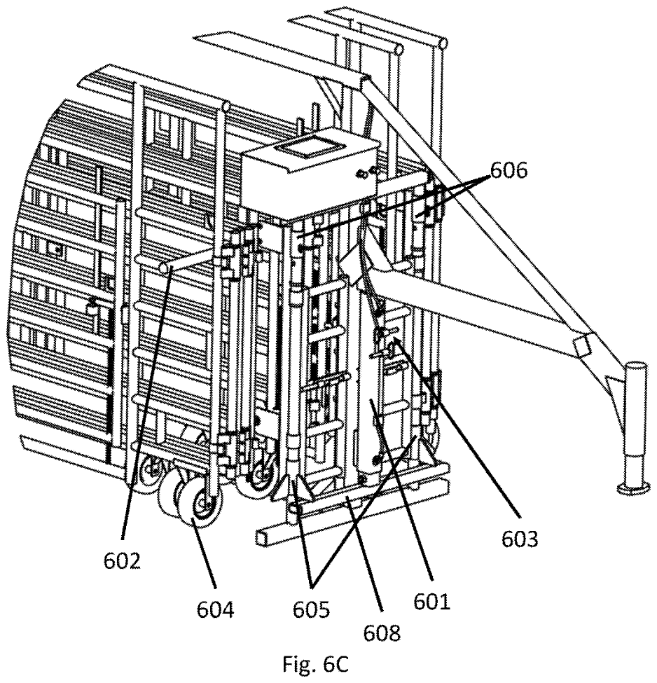

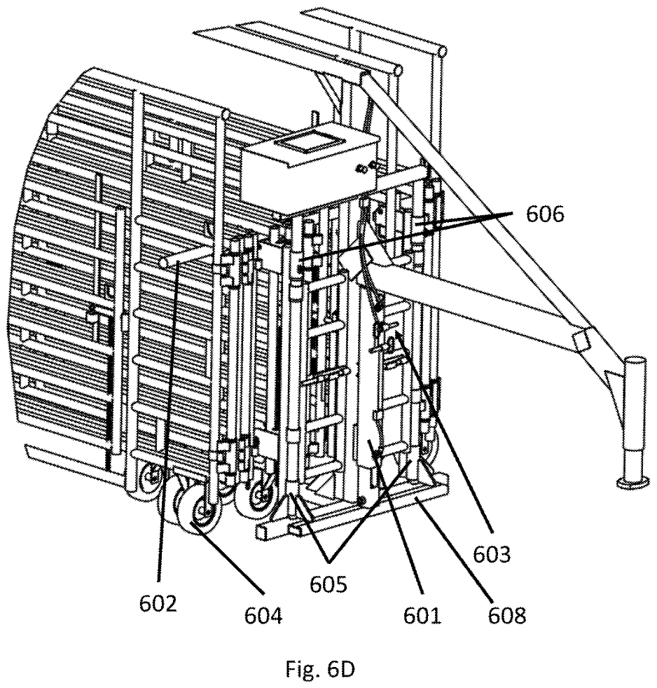

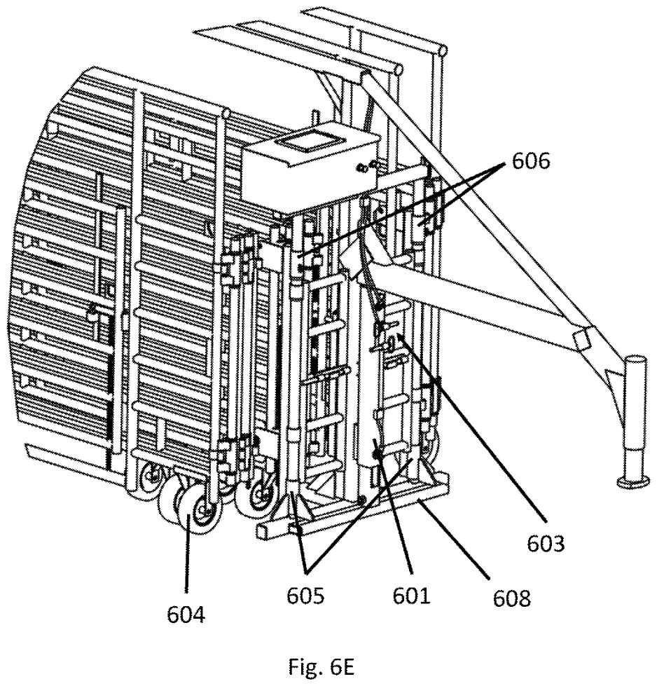

Referring to FIG. 6, embodiments of the portable corral system of the present invention further comprise a panel lifting system 60 and method of using the same to retain the plurality of folding panels of the portable corral system in a lifted position when the portable corral system is in the transport configuration. In various embodiments, the panel lifting system 60 is configured to raise the plurality of folding panels and retain them in a position such that the bottom of each of the panels and/or the panel wheels are raised above the bottom of the frame structure of the portable corral system. Such a lifting system protects the panels from being damaged due to contact with the ground during travel when the portable corral system is in the transport configuration.

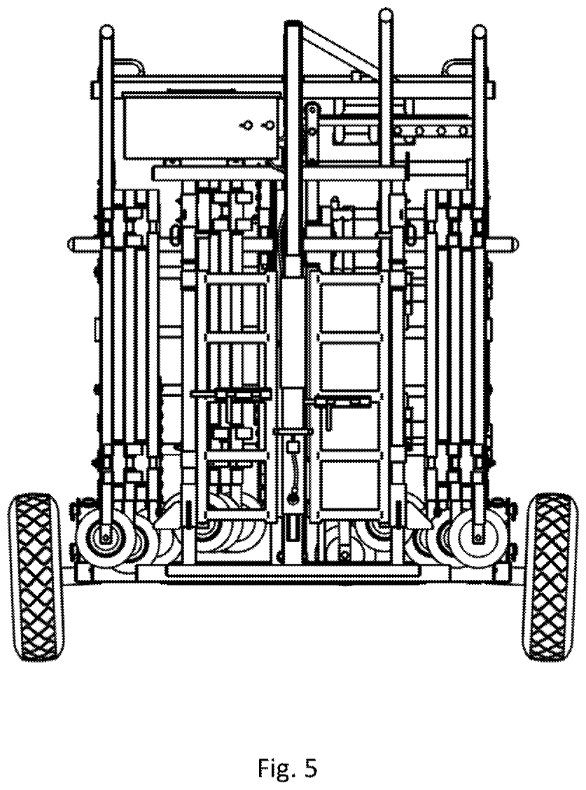

Referring to FIGS. 6, 7, 8, and 10, in various embodiments of the present invention, such as those seen in FIGS. 2 and 5, the portable corral system of the present invention comprises four sets of foldable panels, each set of foldable panels including a group of panels that are interconnected to one another and folded in on each other when the portable corral system is in the transport and lowered configurations. In such embodiments, two sets of foldable panels are stowed on one side of a fixed panel 1001 of the frame structure and the other two sets of foldable panels are stowed on the other side of the fixed panel 1001 of the frame structure. In some such embodiments in which the portable corral system comprises a panel lifting system, at least one set of panels comprises at least one lifting panel that is slidably and rotatably connected to a vertical bar of the frame structure by one or more sleeves 606, one of said sleeves comprising a cleat 605 protruding outwardly from the sleeve. At least some sets of panels further comprise at least one non-lifting panel. In such embodiments, the panel lifting system of the present invention is configured to lift the lifting panels by mechanisms discussed below.

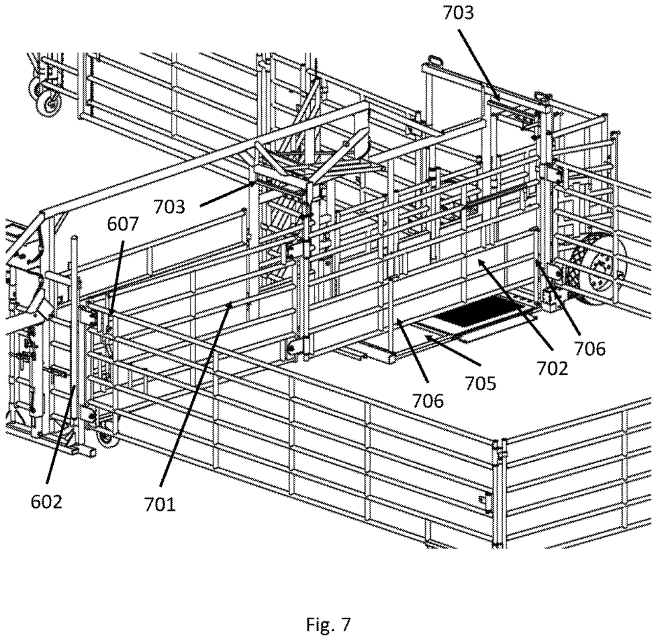

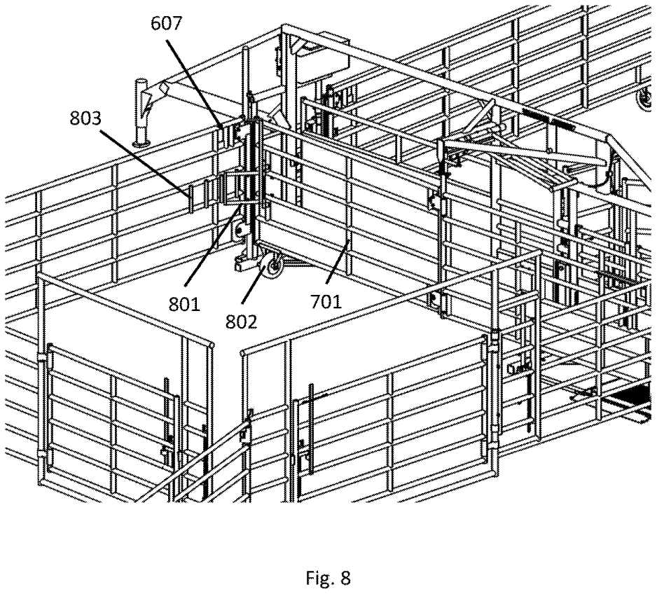

The lifting panels further define one or more receptacles 607 configured to receive a lifting bar 602 of the panel lifting system that extends through each of the panels of each set when the portable corral system is in the transport configuration or lowered configuration. The lifting bar 602 is configured to lift the non-lifting panels as the lifting panel is lifted by the panel lifting system. Each receptacle 607 comprises two vertical bars each extending between first and second horizontal bars of the lifting panel to ensure that the lifting bar 602 does not move out of the receptacle 607. In some embodiments, such as the one shown in FIGS. 7 and 8, each receptacle 607 further comprises a spacer between the two vertical bars of the receptacle 607 and extending upwardly from the first horizontal bar to reduce the vertical gap between an upper surface of the lifting bar 602 and a lower surface of the second bar. In such embodiments, when the panel lifting system lifts the lifting panel, the lifting bar 602 provides a downward force on the spacer and an upward force on a horizontal bar of the non-lifting panels, the spacer being configured in such a scenario to reduce any vertical separation between the lifting panels and the non-lifting panels when the panel lifting system raises the foldable panels into the lifted position. In some embodiments, such as that shown in FIG. 8, the frame structure is configured to securely hold the lifting bar 602 when it is not in use.

Referring now to FIG. 6A, the front end of an embodiment of a portable corral system in the transport configuration comprising a panel lifting system 60 is presented. The panel lifting system comprises at least one hydraulic lifting cylinder 601 that is configured to raise and lower a foot piece 608. As the hydraulic lifting cylinder 601 raises the foot piece 608 the foot piece 608 encounters and lifts the cleat 605 of the lifting panels. Lifting the cleat 605 causes the hydraulic lifting cylinder 601 to raise the lifting panel, thereby raising the lifting bar 602, thereby raising the non-lifting panels through which the lifting bar 602 extends, until the panels reach the lifted position. The panel lifting system further comprises two support pins 603 that fit into two corresponding apertures in the vertical bars of the frame structure to which the lifting panels are connected in a position under the sleeve 606 of each lifting panel when the lifting panels are in the lifted position. The support pins 603, thereby hold the panels in the lifted position, allowing the hydraulic lifting cylinder 601 to lower without simultaneously lowering the panels. Therefore, as seen in FIG. 6A, the panel lifting system of the present invention is configured to hold the panels in the lifted position when the portable corral system is in the transport configuration.

Referring to FIGS. 6B-E, the panel lifting system is configured to lower the panels from the lifted position to a resting position when the portable corral system moves from the transport configuration to the lowered configuration. First, in FIG. 6B, the hydraulic lifting cylinder 601 raises the cleat 605 until the panels are resting on the lifting bar 602 instead of the support pins 603. This allows an operator to remove the support pins 603 from the frame structure, as seen in FIG. 6c. With the support pins 603 removed from the frame structure, the hydraulic lifting cylinder 601 then lowers the cleat 605 until the panels are in the resting position with the bottom of the panels and/or the panel wheels 604 on the ground, as seen in FIG. 6D. With the panels in the resting position, an operator can now remove the lifting bar 602 from the panels and the receptacles 607, thereby facilitating movement of the portable corral system of the present invention to a selected operational configuration. In some embodiments, at least one lifting panel includes a secondary cleat 605B positioned over the lower foot piece 608 when such lifting panel is in a deployed configuration, thereby reducing the risk of inadvertent damage to the primary cleat 605 when moving the lifting panel back to its stowed configuration. In some such embodiments, each cleat extends radially from the sleeve, the second secondary cleat 605B being oriented 90 degrees from the primary cleat 605. In some embodiments, a horizontal plate (not shown) extends between respective bottom edges of the primary 605 and secondary 605B cleats, thereby further reducing risk of potential damage to the primary cleat 605.

In other, not-shown, embodiments, the panel lifting system comprises a hydraulic lifting cylinder that is configured to raise the entirety of the portable corral system. In such embodiments, the panel lifting system comprises a support arm that is attached to a sleeve of the lifting panels and is configured to be placed on the ground while the portable corral system is raised. Therefore, when the portable corral system is then lowered, the panels remain stationary due to the support arm supporting the lifting panels and the lifting bar supporting the non-lifting panels, lifting the panels relative to the frame structure, allowing the support pins to be placed into the frame structure, holding the panels in the lifted position. The hydraulic lifting cylinder then raises the frame structure again such that the frame structure is supporting the weight of the panels. With the frame structure now supporting the weight of the panels, the support arm can then be removed, with the support pins holding the panels in the lifted position. In such embodiments, moving the panels from the lifted to the rested position comprises first utilizing the hydraulic lifting cylinder to lift the frame structure until the panels are supported by the lifting bar, placing the support arm on the ground, lowering the frame structure such that the lifting panels are supported by the support arm, removing the support pins, raising the frame structure until the panels are supported by the lifting bar, lowering the portable corral system to the ground until the panels are in the resting position, and removing the lifting bar. In some embodiments, the support arm is rotatably attached to the panels such that it can rotate down to be placed on the ground when in use and rotated up out of the way when not in use.

In some embodiments, the portable corral system of the present invention comprises multiple panel lifting systems. In some such embodiments, the portable corral system comprises a front panel lifting system comprising a front hydraulic lifting cylinder 601 configured to raise the front end of the portable corral system and/or a front end of foldable panels and an aft panel lifting system comprising ab aft hydraulic lifting cylinder 1002 configured to raise the aft end of the portable corral system and/or an aft end of the foldable panels. In some such embodiments, each lifting panel comprises a front receptacle located substantially near the front end of the lifting panel and an aft receptacle located substantially near the aft end of the lifting panel, both the front and aft receptacles being configured to receive the lifting bar. In other such embodiments, each set of panels comprises two lifting panels, one configured to serve as the lifting panel for the front panel lifting system and, therefore, comprising a receptacle located substantially near the front end when the portable corral system is in the lowered and transport configurations, and the other lifting panel configured to serve as the lifting panel for the aft panel lifting system and, therefore, comprising a receptacle located substantially near the aft end when the portable corral system is in the lowered and transport configurations. In other embodiments, the portable corral system comprises only a singular lifting system and, therefore, only a singular hydraulic lifting cylinder configured to raise the entire portable corral system and/or both ends of each of the sets of panels.

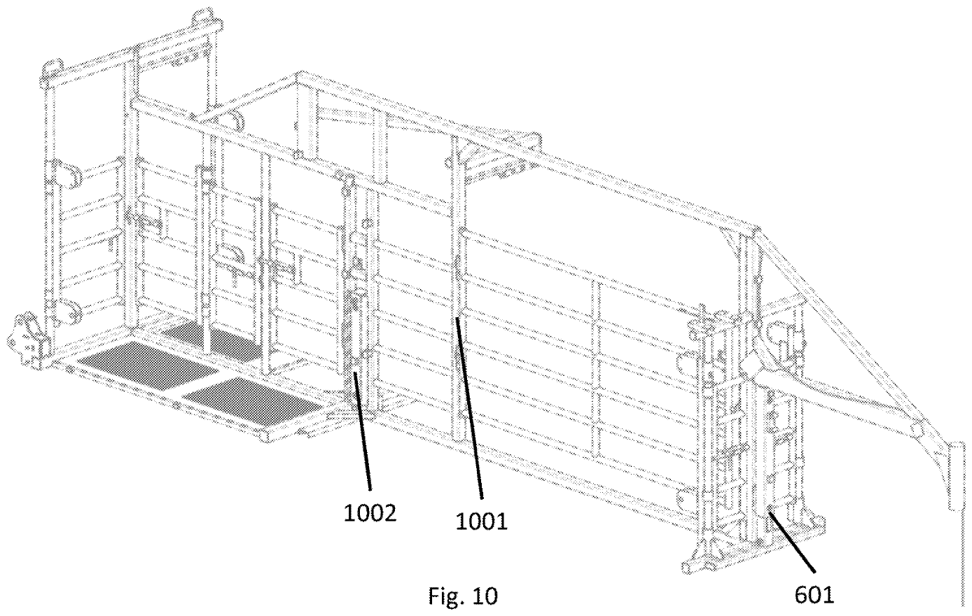

In a preferred embodiment, such as that seen in FIG. 10, the portable corral system comprises a front panel lifting system comprising a front hydraulic lifting cylinder 601 and an aft panel lifting system comprising an aft hydraulic lifting cylinder 1002. In the shown embodiment, the front panel lifting system is configured to raise the front panels using a cleat 605 attached to the lifting panels, and the aft panel lifting system is configured to raise the entire aft end of the portable corral system with a support arm using the methods described above. In such embodiments, the aft panel lifting system can also be utilized for removing and inserting the holding pins 103 into the pivot axle assembly 101 to transition the transport wheels 102 as described above.

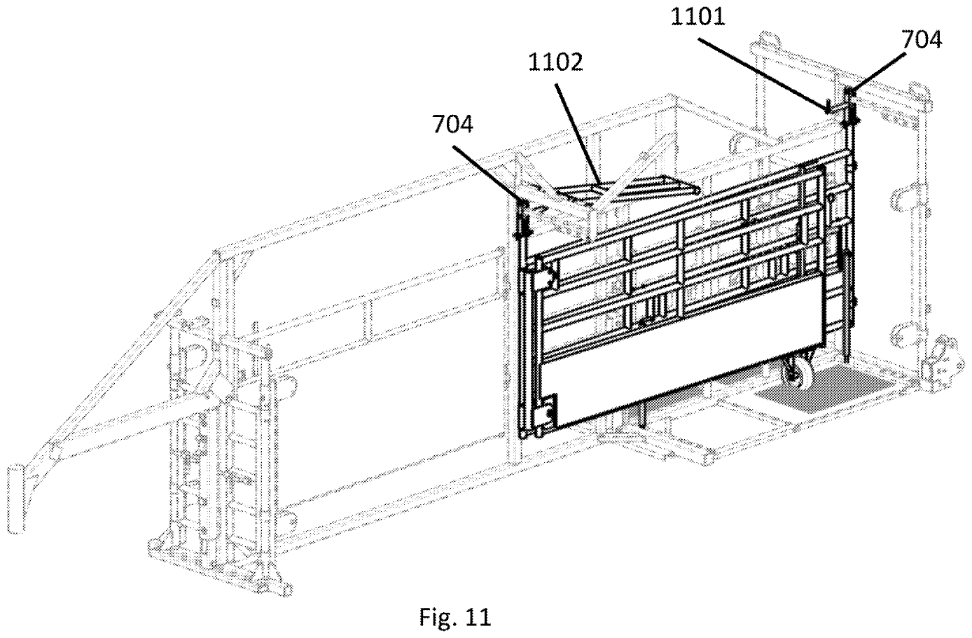

Referring to FIGS. 1C, 7, 9, 10, and 11 a portable corral system with a collapsible alleyway system is presented. In the shown embodiments, the collapsible alleyway system comprises two alleyway panels including a gate panel 701 and a slidable panel 702, the gate panel 701 attached to an end of the slidable panel 702 and configured to fold in towards the slidable panel 702. The collapsible alleyway system is configured to move between an alley configuration and a stowed configuration when the portable corral system is in at least some of the plurality of operational configurations. In the alley configuration, the collapsible alleyway system is configured to form an alleyway 901 for working cattle or other livestock between the slidable panel 702 and a fixed panel 1001 located at the center of the frame structure. In the stowed configuration, the alleyway panels are configured to be stowed substantially near the center of the frame structure, thereby leaving space on each of the four corners of the portable corral system to stow foldable panels. In the shown embodiment, moving the collapsible alleyway system from the alley configuration to the stowed configuration comprises folding the gate panel 701 in towards the slidable panel 702 until they meet, and then moving both panels in towards the center of the frame structure.

Various embodiments of the collapsible alleyway system of the present invention further comprises one or more horizontal mounting pieces 703 located on the frame structure that are configured to hold and support one or more corresponding rolling mounts 704 located on the upper end of the slidable panel 702. The rolling mounts allow the slidable panel 702, and, therefore, the attached gate panel 701, to be moved towards and away from the center of the frame structure, thereby, moving the collapsible alleyway system between the stowed configuration and the alley configuration. In the shown embodiment, the frame structure comprises two horizontal mounting pieces 703 configured to support two corresponding rolling mounts 704 of the slidable panel 702. In other embodiments, various numbers of mounting pieces and/or rolling mounts are utilized which simultaneously support the weight of the slidable panel 702 and allow it to move towards and away from the slidable panel 702.

In various embodiments, the collapsible alleyway system further comprises a frame base 705 located on the bottom of the frame structure, defining one or more series of apertures each configured to receive the lower end of one or more locking pieces 706 located on the slidable panel 702. In the shown embodiment, the frame base 705 defines two series of apertures for receiving the two corresponding locking pieces 706 of the slidable panel, each aperture in the series of apertures of the frame base 705 corresponding to a different width of the created alleyway 901, thereby allowing the alleyway 901 formed by the collapsible alleyway system to be adjustable. In this embodiment, moving the collapsible alleyway system from the stowed configuration to the alley configuration comprises lifting the locking pieces 706 on the slidable panel 702 and moving the slidable panel away from the center of the frame structure towards until the desired alley width is reached, at which point the locking pieces 706 are moved downward into one of the corresponding apertures on the frame base 705. When the locking pieces 706 are at least partially within the apertures of the frame base 705, the movement of the slidable panel 702 towards and away from the center of the frame structure is restricted, thereby retaining an alleyway of a desired width for use by an operator.

In some embodiments, the collapsible alleyway system further comprises a spring-loaded latch 1101 for each of the rolling mounts 704 configured to restrain the movement of the respective rolling mount 704 until the spring-loaded latch 1101 is unlatched, thus further restraining movement of the slidable panel 702. In the shown embodiment, in which the slidable panel 702 comprises two rolling mounts 704, each rolling mount 704 comprises a corresponding spring-loaded latch 1101. In some such embodiments, the collapsible alleyway comprises a cable attached to and extending between the spring-loaded latches 1101 such that when pulled on by an operator both latches are unlatched. Therefore, in order to move the slidable alleyway 702 towards and away from the center of the frame structure, an operator must pull on the cable, unlatching the spring-loaded latches 1101, releasing their restraint on the movement of the rolling mounts 704. It will be appreciated that various embodiments of the collapsible alleyway of the present invention comprise different mechanisms for unlatching the spring-loaded latches 1101, as such mechanisms are known in the art. It will further be appreciated that other embodiments of collapsible alleyways of the present invention utilize other means of restraining the movement of the slidable panel 702 as will be readily appreciated by those of skill in the art.

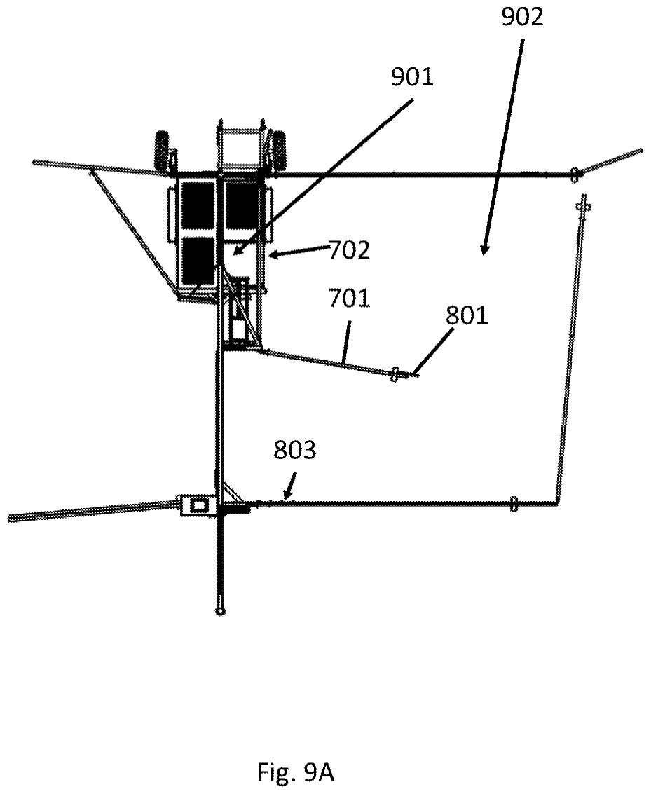

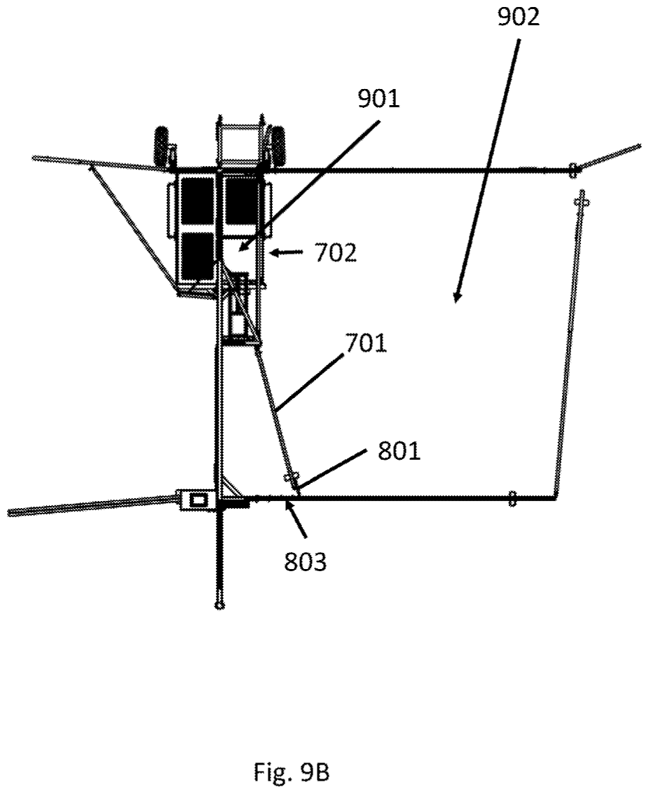

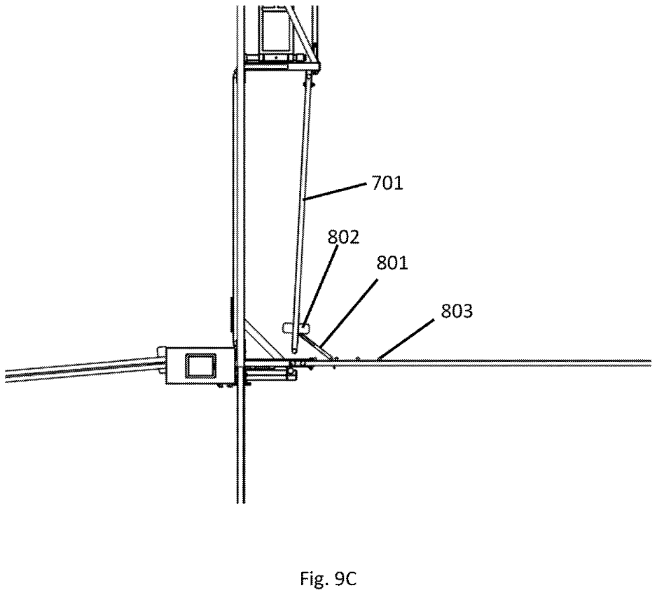

In various embodiments of the collapsible alleyway of the present invention, the gate panel 701 comprises a tub latch 801 and a gate panel wheel 802, each located substantially near a distal end of the gate panel 701. The gate panel wheel 802 is configured to allow the gate panel 701 to rotate towards and away from the slidable panel 702. The gate panel 701 is of a sufficient length such that when it is rotated near 180 degrees, it spans the gap between the slidable panel 702 and the front end of the frame structure. As such, when the gate panel 701 rotates towards and away from the slidable panel 702, it opens and closes a gap configured to allow cattle or other livestock to enter into the alleyway 901. The opening and closing of the gate panel 701 is shown in FIGS. 9A-9C.

In various embodiments of the collapsible alleyway of the present invention, the collapsible alleyway of the present invention further comprises a moveable backstop 1102 rotatably attached to the top of the frame structure and configured to provide a backstop for the alleyway 901 to keep cattle or other livestock in the alleyway 901 while an operator is working with them. The moveable backstop 1102 is further configured to rotate upwards above the alleyway panels to get out of the way to allow cattle or other livestock to enter the alleyway 901. The moveable backstop 1102 further comprises a locking mechanism configured to restrict the rotation of the moveable backstop 1102 away from its upward or downward position. The moveable backstop's locking mechanism, therefore, is able to hold the moveable backstop 1102 in its upward position out of the way of the alleyway panels as the collapsible alleyway moves between the alley configuration and the stowed configuration. It is further able to hold the moveable backstop 1102 in its downward position to provide a secure backstop for the alleyway 901.

The tub latch 801 is connected to the gate panel 701 and configured to restrain the rotation of the gate panel 701 when the gate is closed, such as to prevent cattle from backing out of the alleyway. In the shown embodiment, the tub latch 801 is rotatably connected to the gate panel 701 in such a way that when the gate closes it encounters one of the foldable panels, thereby causing the tub latch 801 to rotate outwardly away from the gate panel 701. In the shown embodiment, the foldable panel that the gate connection piece 801 encounters comprises one or more vertical locking bars 803, each configured to restrain the rotation of the gate panel 701 towards the slidable panel 702 by encountering the tub latch 801. In the shown embodiment, the collapsible alleyway system comprises three vertical locking bars each configured to hold the gate panel 701 at a specified degree of rotation with respect to the slidable panel 702. In such embodiments, the gate panel 701 is configured to be opened by manually rotating the tub latch 801 towards the gate panel 701 until it will no longer encounter the one or more vertical locking bars 803, and subsequently rotating the gate panel 701 outwardly towards the slidable panel 702. As such, the tub latch 801 and the vertical locking bars 803 are configured to restrain the movement of the gate panel 701 and, thereby, keep the gate closed until the gate connection piece is manually rotated to open the gate. In some embodiments, a biasing mechanism, such as a spring or the like, biases the tub latch towards an extended configuration, thereby biasing the tub latch into engagement with the vertical locking bars. In some such embodiments, engagement with the vertical locking bars while moving the gate panel 701 towards a closed position overcomes a biasing force of the biasing member such that the tub latch clicks past each vertical locking bar while moving the gate panel 701 towards a closed configuration. It will be appreciated that other embodiments of the collapsible alleyway of the present invention comprise different mechanisms for keeping the gate panel 701 closed, as such mechanisms are known in the art.

Embodiments of the present invention further comprise methods for deploying a corral and/or an alleyway using a portable corral system comprising the features described herein. In some embodiments, the method comprises moving the portable corral system from a transport configuration to a lowered configuration by moving the portable corral system onto the ground. In some such embodiments in which the portable corral system comprises one or more pivot axle assemblies 101, moving the portable corral system from the transport configuration to the lowered configuration comprises rotating the transport wheels 102 out from beneath the portable corral system by, in some embodiments, removing a retention pin 103 from each of the pivot axle assemblies 101. In some such embodiments, the method further comprises placing the weight of the portable corral assembly on a hydraulic lifting cylinder prior to removing the retention pin 103, and lowering the hydraulic lifting cylinder after the retention pin 103 has been removed, thereby causing the transport wheels 102 to rotate due to the weight of the portable corral assembly. In some such embodiments in which the portable corral assembly comprises one or more panel lifting systems described above, moving the portable corral system from the transport configuration to the lowered configuration comprises moving the plurality of foldable panels from a lifted position to a resting position using the mechanisms described above.

In some embodiments, the method comprises moving the portable corral system from a lowered configuration to a selected operational configuration by first unfolding the panels from their stowed positions within the frame structure to deploy a corral at a desired location. In some such embodiments, moving the portable corral system from the lowered configuration to the selected operational configuration further comprises deploying an alleyway using a collapsible alleyway system using the mechanisms described above. It will be appreciated that the inverse of the steps described herein for deploying the portable corral system from the transport configuration to the lowered configuration to the selected operational configuration can be used to move the portable corral system from the selected operational configuration to the lowered configuration to the transport configuration.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, various embodiments of the present technology include a variety of combinations and/or integrations of the embodiments described herein.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A portable corral system configured to be moveable between a transport configuration and a selected operational configuration, the system comprising:
a frame structure having a front end and an opposing aft end; and
one or more pivot axle assemblies each configured to rotatably couple a transport wheel to the frame structure substantially near the aft end,
wherein each pivot axle assembly is configured to retain the corresponding transport wheel in a location substantially below the frame structure such that said portable corral system is supported by the one or more transport wheels when the portable corral system is in the transport configuration, and
wherein each pivot axle assembly is configured such that the corresponding transport wheel can be moved out from beneath the frame structure while remaining attached to the frame structure until the frame structure is positioned on the ground as the portable corral system moves from the transport configuration to the operational configuration.

2. The portable corral system of claim 1 wherein each pivot axle assembly comprises:
a pivot arm configured to be coupled to a central hub of the transport wheel at a first end; and
a bracket affixed to the frame structure, the bracket being configured to be rotatably coupled to a second end of the pivot arm,
wherein the transport wheel moving out from beneath the frame structure is a product of the pivot arm rotating away from the bracket.

3. The portable corral system of claim 2 wherein each pivot axle assembly comprises a holding pin configured to restrict the rotation of the pivot arm away from the bracket when the portable corral system is in the transport configuration.

4. The portable corral system of claim 3 wherein the pivot arm comprises a first tube defining the first end, and a second tube angularly connected to the first tube, the second tube defining the second end.

5. The portable corral system of claim 1 wherein each pivot axle assembly is configured such that the camber of the transport wheels is adjustable to accommodate for differing weights of the portable corral system.

6. The portable corral system of claim 1 wherein each pivot axle assembly is configured such that the movement of the transport wheels out from beneath the frame structure as the portable corral system moves from the transport configuration to the operational configuration is caused by the weight of the portable corral system.

7. The portable corral system of claim 1 wherein each pivot axle assembly is configured to utilize the weight of the corresponding transport wheel to move the transport wheel back into position below the frame structure as the portable corral system moves from the operational configuration to the transport configuration.

8. The portable corral system of claim 1 wherein each pivot axle assembly is configured to receive a holding pin that restricts the movement of the corresponding transport wheel, thereby retaining the transport wheel in its position under the frame structure when the portable corral system is in the transport configuration.

9. The portable corral system of claim 8 wherein each pivot axle assembly is configured such that moving the portable corral system from the transport configuration to the operational configuration comprises removing the holding pin from the pivot axle assembly.

10. The portable corral system of claim 1 wherein each pivot axle assembly is configured such that the corresponding transport wheel can be removed entirely from the frame structure by removing a coupling pin from the pivot axle assembly.

11. A portable corral system configured to be moveable between an operational configuration and a deployed configuration, the portable corral system comprising:
a frame structure defining a front end, an aft end, and a frame area extending therebetween;
a plurality of foldable panels configured to be folded together and stowed within the frame area when the portable corral system is in the operational configuration, the plurality of folding panels being further configured to be folded out to deploy a corral space when the portable corral system is in the deployed configuration; and
a collapsible alleyway system moveable between an alley configuration and a stowed configuration when the portable corral system is in the deployed configuration,
wherein in the alley configuration the collapsible alleyway system is configured to use one or more alleyway panels to deploy an alleyway,
wherein, in the stowed configuration, the collapsible alleyway system is configured to stow the one or more alleyway panels substantially centrally within the frame area when the portable corral system is in the operational configuration to maximize the available space within the frame area for stowing the plurality of foldable panels.

12. The portable corral system of claim 11 wherein one of the one or more alleyway panels is a slidable panel comprising one or more rolling mounts configured to roll along one or more corresponding mounting pieces of the frame structure as the collapsible alleyway system moves between the alley configuration and the stowed configuration.

13. The portable corral system of claim 12 wherein the one or more alleyway panels further comprise a gate panel rotatably attached to one end of the slidable panel and configured to rotate away from the slidable panel to create a gate for the alleyway.

14. The portable corral system of claim 13 wherein the gate panel further comprises a gate locking mechanism configured to restrict the rotation of the gate panel towards the slidable panel when the gate is closed.

15. The portable corral system of claim 14 wherein the gate locking mechanism comprises a gate attachment piece located on the gate panel and one or more vertical locking bars located on one of the plurality of foldable panels.

16. The portable corral system of claim 12 wherein the frame structure comprises a frame structure base defining one or more apertures each configured to receive at least a portion of a corresponding locking piece located on the slidable panel, thereby restricting the movement of the slidable panel.

17. The portable corral system of claim 12 wherein the collapsible alleyway system further comprises one or more spring loaded latch each configured to restrain the movement of one of the one or more the rolling mounts, thereby restricting the movement of the slidable panel.

18. A portable corral system configured to be moveable between a transport configuration and an operational configuration, the portable corral system comprising:
a frame structure defining a front end, an aft end, and a frame area extending therebetween;
a plurality of foldable panels configured to be folded together and stowed within the frame area; and
one or more panel lifting systems are each configured to raise at least one end of the plurality of foldable panels to a lifted position when the portable corral system is in the transport configuration,
wherein the foldable panels, when in the lifted position, are raised relative to the frame structure such that a bottom end of the panels are protected from damage during travel of the portable corral system.

19. The portable corral system of claim 18
wherein the one or more panel lifting systems comprises a front panel lifting system configured to raise the front end of the plurality of foldable panels to the lifted position and ab aft panel lifting system configured to raise the aft end of the plurality of foldable panels to the lifted position.

20. The portable corral system of claim 18 wherein the plurality of foldable panels comprise at least one lifting panel configured to be raised by the one or more panel lifting systems and configured to receive a lifting bar, and
wherein the plurality of panels comprise at least one non lifting panel configured to be raised by the lifting bar as the at least one lifting panel is raised by the one or more panel lifting systems.
